(19) United States
(12) Patent Application Publication
(10) Pub. No.: US 2003/0217147 A1
(43) Pub. Date: Nov. 20, 2003

(54) Directing a client computer to a least network latency server site

(76) Inventors: William P. Maynard, San Diego, CA (US); John A. Malo JR., San Diego, CA (US)

Correspondence Address: KENYON & KENYON, 1500 K STREET, N.W., SUITE 700, WASHINGTON, DC, 20005, US

(21) Appl. No.: 10/143,802

(22) Filed: May 14, 2002

(51) Int. Cl. G06F 15/16; G06F 15/173

(52) U.S. Cl. 709/225; 709/203

(57) ABSTRACT

A method of determining network latency includes receiving a Uniform Resource Locator (URL) request at a first server site from a remote computer. The method further includes generating a timing Web page, which includes information regarding a plurality of server sites, at the first server site. The method further includes transmitting the timing Web page to the remote computer and determining a fastest site among the plurality of server sites.

### FIELD OF THE INVENTION

One embodiment of the present invention is directed to computer networks. More particularly, one embodiment of the present invention is directed to accessing data over a computer network from a group of computer server sites.

### BACKGROUND INFORMATION

Many Internet Web sites appear to the user as a single site on a single computer. However, most popular sites are composed of multiple computer servers that are frequently located at multiple physical locations on a Wide Area Network (“WAN”). This ensures that a site does not have a single point of failure to the outside world.

Each physical site on a WAN requires at least one Virtual Internet Protocol (“VIP”) address that can be selected by a client computer when accessing the Web site. To distribute the traffic load more evenly among the multiple physical sites a Multi-Site Load Balancer (“MSLB”) is typically used.

The MSLB is often used to send the client to a site that will hopefully give the quickest overall response back to the client. Factors that influence this response include network latency and server response time. The server response time is often dependent on several factors itself such as how many people are connected, how much data are they transferring, and how much additional processing must the server do for each request. Network latency is a measure of how quickly packets can get to the site through the network.

MSLBs obtain performance metrics (e.g., number of connections, processor loading, etc.) from each site they balance. This information may be gathered from a local load balancer located at each physical site, or directly from the servers themselves. This information is then used to refer the client to the site with best performance metric.

The most common implementation for multi-site load balancing is to load balance the Domain Name Service (“DNS”) requests for the host name portion of the Uniform Resource Locator (“URL”). When a URL is entered on a Web browser or a link is clicked, the client's name server must translate the host name into an IP address. This request will eventually work its way through the Internet until it finds a server that claims to have an authoritative answer for the request. At this point the request can be balanced. The name server responding to the request uses one of several methods to determine the best available site of the moment and responds back to the client with the VIP for the physical site best able to handle the request at the time the request was made.

Load balancing using DNS requests has several drawbacks. The first problem is that name servers tend to cache the DNS responses to their requests. This results in the MSLB being able to influence a smaller percentage of the traffic directly in real time. It also means that for every query the MSLB answers, tens or even thousands of connections may actually be referred to the site. The second disadvantage is that a client's name server does not have to be located anywhere near where the client is on the network. For example, America Online (“AOL”) uses name server farms at a single site for the entire country. This means that any form of load balancing based on network latency between sites and the client's name server may not be a good indicator of the network latency between a client and a site.

One known solution to these problems is for the MSLB to perform HyperText Transport Protocol (“HTTP”) redirection. The client's name server is given the address of an MSLB that will receive the client's initial request for a page. Using the information that the load balancer knows about site availability, which sites have the desired page and site loading, the MSLB will respond to the client's request with an HTTP response that redirects the client to an actual site.

The problem with HTTP redirection is that there is currently no easy way for the MSLB to direct the client to the site that will give the best overall response time. The load balancer can direct the client to the site whose servers can give the best response, but this may not be the optimal site. The network latency between the client and the site with the best performance metrics may actually have the worst network latency. Therefore, although the servers can respond instantly, it may take hundreds of milliseconds for each packet to traverse the Internet from the client to the site.

Some sites attempt to overcome this problem by using active server pages. When the client requests a page the server looks up the client's Internet Protocol (“IP”) address in a database and refers the client to the site that the database says is the “closest”. This approach often does not take into account the current load or availability of the site the client is referred to. It is also difficult, if not impossible, to capture network latency in a database since network congestion can vary at any given moment.

Based on the foregoing, there is a need for an improved method for directing a client to the server with the least network latency.

### BRIEF DESCRIPTION OF THE DRAWINGS

FIG. 1 is an overview diagram of a communication system in accordance with one embodiment of the present invention.

FIG. 2 is a flow diagram of the functionality performed by the system in accordance with one embodiment of the present invention.

FIG. 3 illustrates a timing Web page in accordance with the embodiment of the present invention described in FIG. 2.

FIG. 4 is a flow diagram of the functionality performed by the system in accordance with another embodiment of the present invention.

FIG. 5 illustrates a timing Web page that is returned by a server site in accordance with the embodiment of the present invention described in FIG. 4.

FIG. 6 is a flow diagram of the functionality performed by the system in accordance with another embodiment of the present invention.

### DETAILED DESCRIPTION

One embodiment of the present invention is a method of determining the network latency between the client and potential server sites at the moment in time the client requests the connection by sending a timing Web page from a server to the client. The method also ensures that the client will actually be able to reach and connect to the server site that was referred to the client.

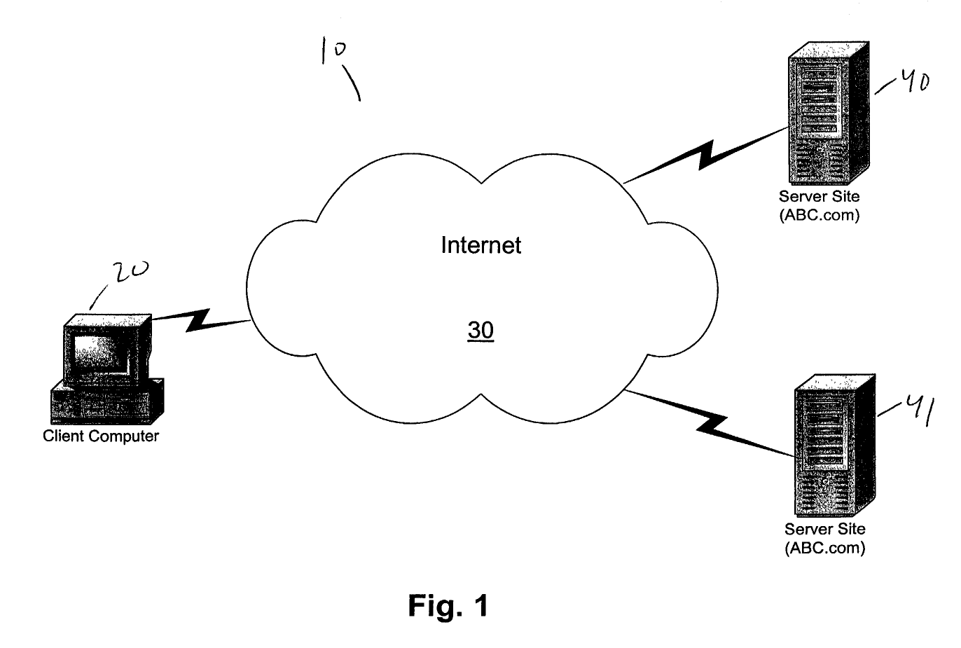

FIG. 1 is an overview diagram of a communication system 10 in accordance with one embodiment of the present invention. System 10 includes a client computer 20 coupled to the Internet 30. Client computer 20 may be any type of computer or other device that is capable of accessing Internet 30. In one embodiment, client computer 20 includes a processor and memory, and executes an Internet Web browser, such as the Internet Explorer browser from Microsoft Corp. In one embodiment, the processor is the Pentium 4 processor from Intel Corp.

Client computer 20 accesses Internet 30 using any known manner. In one embodiment, client computer 20 accesses Internet 30 through a dial-up connection over the Public Switched Telephone Network (“PSTN”) to an Internet Service Provider (“ISP”). In another embodiment, client computer 20 accesses Internet 30 through a cable network using a cable modem.

Internet 30 comprises a plurality of servers, routers, etc. Many of the servers store Web pages that can be accessed through client computer 20 by typing or clicking on a URL such as XXX.com. Unbeknownst to a user at client computer 20, selecting the URL may retrieve the requested Web page from one of many servers at the same physical location linked together by a local area network (“LAN”), referred to as a “server farm”. Selecting the URL may also retrieve the requested Web page from a server at one of many different physical locations linked together by a WAN.

System 10 includes server sites 40 and 41 which represent physically different sites housing Web servers for URL “ABC.com”. Each server site 40, 41 includes at least one server computer that includes a processor and memory. The memory can store instructions that are executed by the processor to provide the functionality of one embodiment of the present invention, as described below. The memory also stores Web pages that are sent to client computer 20 in response to requests for URL ABC.com. Each server site 40, 41 is associated with at least one Virtual Internet Protocol (“VIP”) address. Other embodiments of the present invention include more than two server sites.

In one embodiment, each server site 40, 41 includes multiple server computers that form a server farm. In this embodiment, each server site 40, 41 includes a local load balancer coupled to the multiple servers. The local load balancer selectively forwards connections to the many servers arrayed behind it in an equitable manner, according to the server's operational health and the nature of the query. In one embodiment, the load balancer is the NetStructure 7180 e-commerce Director from Intel Corp.

In one embodiment, each server site 40, 41 includes a Multi-Site Load Balancer (“MSLB”) that can select an optimal physical site among sites 40, 41 (and any other additional sites if additional sites were included in system 10). In one embodiment, the MSLB is the NetStructure 7190 Multi-Site Traffic Director from Intel Corp. In one embodiment, the MSLB includes a processor and memory. The memory can include instructions that cause the processor to execute functionality described below.

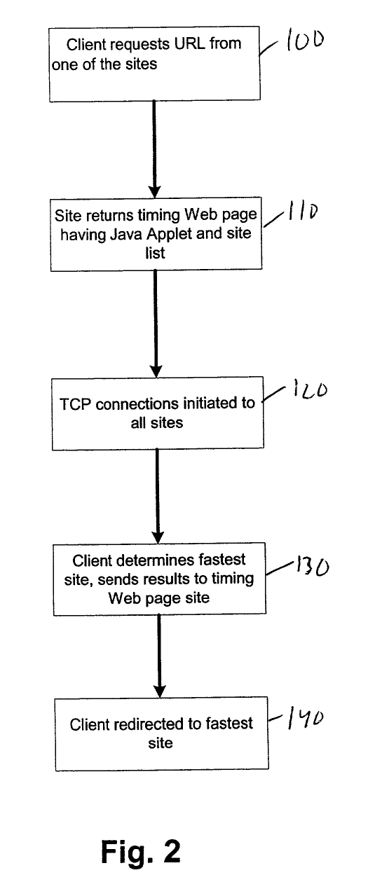

FIG. 2 is a flow diagram of the functionality performed by system 10 in accordance with one embodiment of the present invention. In one embodiment, the functionality is implemented by software stored in memory and executed by a processor. In other embodiments, the functionality can be performed by hardware, or any combination of hardware and software.

At box 100, client computer 20 generates a targeted URL request to one of the server sites (e.g., server site 40). In one embodiment, the URL request typed in or selected by a user (e.g., ABC.com) is directed to a single site (e.g., site 40) by converting the URL request to the VIP address of the single site.

At box 110, the site that received the request at box 100, server site 40, returns to client computer 20 a specialized timing Web page that is downloaded by client computer 20. The Web page can be generated by one of the servers at server site 40, an MSLB at server site 40, or any device at server site 40 capable of generating, by any combination of hardware or software, the Web page at site 40 in response to the URL request.

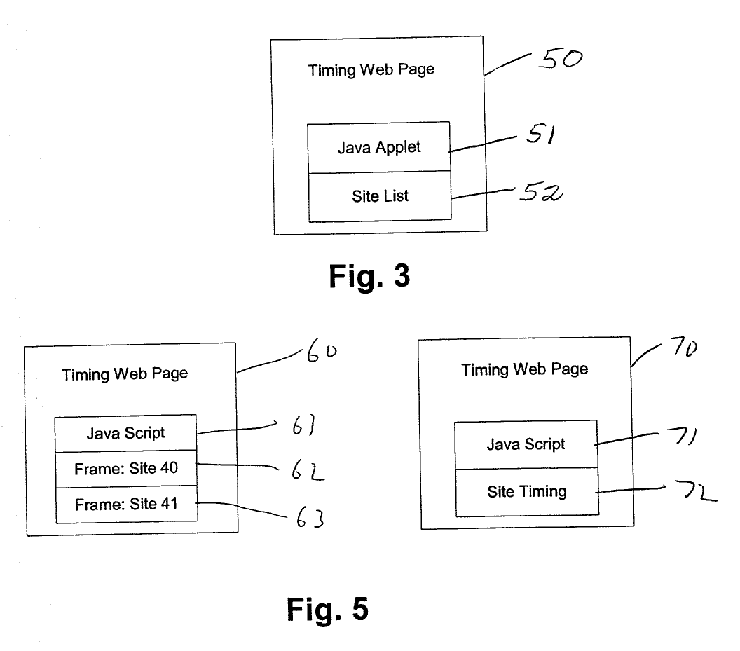

FIG. 3 illustrates a timing Web page 50 in accordance with the embodiment of the present invention described in FIG. 2. Timing Web page 50 includes a Java Applet 51, and a site list 52. Site list 52 lists the VIP address locations of all of the server sites that respond to the URL request. Therefore, in the example of FIG. 1, site list 52 includes sites 40 and 41.

Java Applet 51 includes instructions that initiate Transport Control Protocol (“TCP”) connections to each site on site list 52. In other embodiments, instead of a Java Applet, any type of instructions that are automatically executed at client computer 20 can be used, or instructions that can be executed by a user at client computer 20, such as a Java Script, can be used. At box 120 of FIG. 2, client computer 20 automatically executes Java Applet 51, which initiates the TCP connections. Each TCP connection sends a TCP packet. The TCP packet provides timing information between client computer 20 and each of sites 40, 41 in a known manner.

At box 130, client computer 20 determines the site with the least network latency based on the response from the TCP connection. In one embodiment, client computer 20 then drops the connections to all but the fastest site (i.e., the site with the least amount of network latency), thereby achieving the connection to the site with the least network latency. However, a disadvantage of this embodiment is that the browser at client computer 20 is never actually redirected to the selected site so further requests for pages would result in Java Applet 51 running again.

In another embodiment, at box 130 client computer 20 sends the results of determining the fastest site to the site that sent the timing web page (i.e., site 40). Site 40 then redirects client computer 20 to the site with the least network latency at box 140.

The embodiments described in conjunction with FIG. 2 require client computer 20 to perform the timing of the connections. Because of security settings of a client computer's browser, this may be impractical. For example, some browsers are configured to block the running of all active Java Applets. In the alternative, the following embodiments place the burden on the sites being queried to perform the timing.

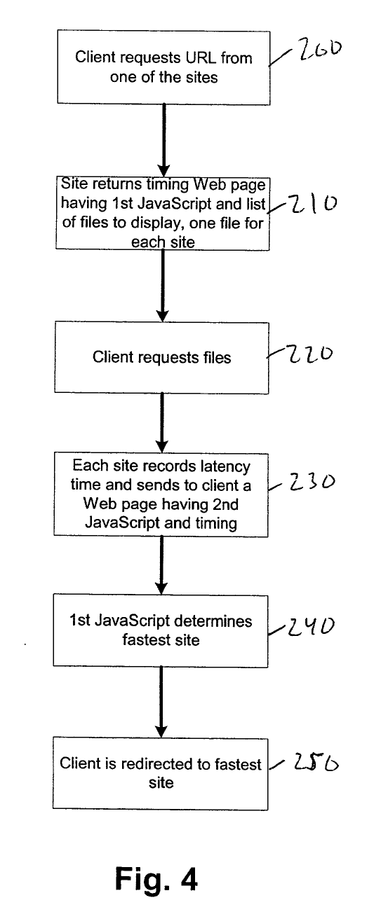

FIG. 4 is a flow diagram of the functionality performed by system 10 in accordance with another embodiment of the present invention. In one embodiment, the functionality is implemented by software stored in memory and executed by a processor. In other embodiments, the functionality can be performed by hardware, or any combination of hardware and software.

At box 200, client computer 20 generates a targeted URL request to one of the server sites (e.g., server site 40). In one embodiment, the URL request typed in or selected by a user (e.g., ABC.com) is directed to a single site (e.g., site 40) by converting the URL request to the VIP of the single site.

At box 210, the site that received the request at box 200, server site 40, returns to client computer 20 a specialized timing Web page that is downloaded by client computer 20. FIG. 5 illustrates a timing Web page 60 that is returned by server site 40 in accordance with the embodiment of the present invention described in FIG. 4. Timing Web page 60 includes a first Java Script 61, and URLs 62 and 63, which are a list of URLs for special files to be displayed, one file for each candidate site. In one embodiment, Java Script 61 and URLs 62, 63 are in frames. One embodiment has a main frame and a separate frame for each candidate site.

At box 220, client computer 20 requests the files on timing Web page 60. In one embodiment, this is automatically done by the Web browser which automatically attempts to get all the linked files contained in Web page 60.

At box 230, a device at each site 40, 41 such as a server computer or MSLB determines network latency by maintaining a record of the amount of time it takes between the SYN plus ACK response back to client computer 20 and client computer's 20 final ACK to complete the TCP connection. Each site 40, 41 then generates and sends to client 20 a Web page 70, as illustrated in FIG. 5. Web page 70 includes Java Script 71 and the site timing 72 between client 20 and the site.

At box 240, the Java Script from Web page 60 determines the fastest time by reading the timing variables in the Web pages 70 generated by each site. Once the site with the least network latency to client computer 20 is determined, all future requests are directed only to that site (box 250).

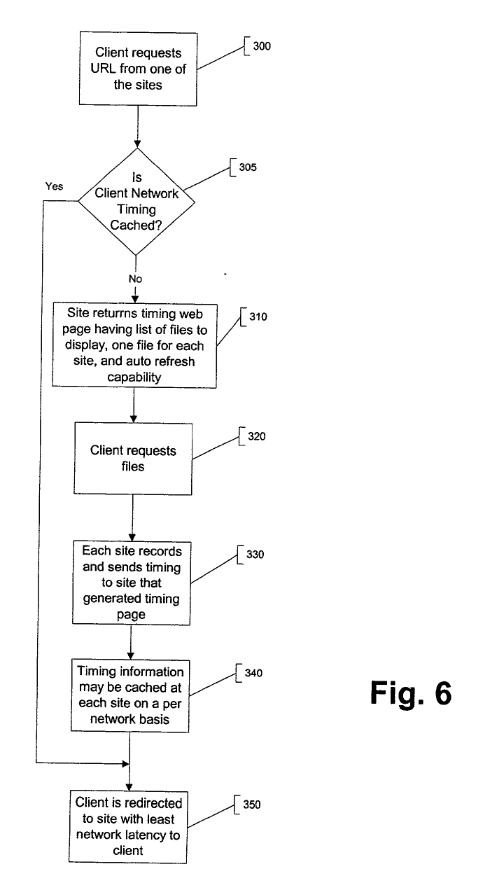

FIG. 6 is a flow diagram of the functionality performed by system 10 in accordance with another embodiment of the present invention.

At box 300, client computer 20 generates a targeted URL request to one of the server sites (e.g., server site 40). In one embodiment, the URL request typed in or selected by a user (e.g., ABC.com) is directed to a single site (e.g., site 40) by converting the URL request to the VIP address of the single site.

At box 310, the site that received the request at box 200, server site 40, returns to client computer 20 a specialized timing Web page that is downloaded by client computer 20. The timing Web page includes a list of URLs for special files to be displayed, one file for each candidate site. The timing Web page further includes an auto-refresh capability to enforce a time limit on how long client computer 20 will wait for a response back from all of the sites. In one embodiment, the auto-refresh capability is implemented by a timer event in JavaScript or an HTML Meta redisplay.

At box 320, client computer 20 automatically requests the files from each site that are included on the timing Web page.

At box 330 a device at each site 40, 41 such as a server computer or MSLB determines network latency by maintaining a record of the amount of time it takes between the SYN plus ACK response back to client computer 20 and client computer's 20 final ACK to complete the TCP connection. Each site sends the timing information to the site (i.e., site 40) that generated the timing Web page at step 310. Site 40 can then determine the fastest site.

At box 340, the fastest site timing information may be optionally sent to and cached at each site on a per network basis and pruned on a fairly frequent basis. If the information is cached, then the cached timing information is examined (decision point 305) prior to sending the timing Web page at box 310. If there is already sufficient timing information in the cache to direct client computer 20 to the fastest site, then the functionality at boxes 310, 320, 330 and 340 is not performed.

At box 350, client computer 20 is redirected to the site with the least network latency. As discussed, above, back to back requests from a client or other clients in the same network will result in immediate redirection without the need for timing if timing information is in the cache, and the Web page at box 310 is not needed. A device at site 40 will respond immediately with a redirection in response to the initial URL request from the client. Otherwise it waits until the auto-refresh causes client 20 to request the URL a second time. This time the device at site 40 is able to answer from its timing cache and redirect the client immediately to the fastest site.

As described, embodiments of the present invention determines the fastest site for a client by sending a timing Web page from a server to the client. The timing Web page includes information for all potential server sites in the form of, for example, a list of VIP address locations of the sites, or URL links to each of the sites. Timing calculations can subsequently be done at either the client or at a device at the server site.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method of determining network latency comprising:
receiving a Uniform Resource Locator (URL) request at a first server site from a remote computer;
generating a timing Web page at the first server site, said timing Web page comprising information regarding a plurality of server sites;
transmitting the timing Web page to the remote computer; and
determining a fastest site with the lowest network latency to the remote computer among the plurality of server sites.

2. The method of claim 1, wherein the fastest site is determined at the remote computer.

3. The method of claim 1, wherein the fastest site is determined at the first server site.

4. The method of claim 1, wherein the information comprises a list of locations of the plurality of server sites.

5. The method of claim 1, wherein the information comprises a URL link to each of the plurality of server sites.

6. The method of claim 4, said timing Web page comprising a Java Applet.

7. The method of claim 4, said determining the fastest site comprises initiating a Transport Control Protocol (TCP) connection to each of the plurality of Web sites.

8. The method of claim 7, further comprising dropping all of the TCP connections except the TCP connection to the fastest site.

9. The method of claim 7, further comprising sending an identity of the fastest site to the first server site.

10. The method of claim 9, further comprising redirecting the remote computer to the fastest site.

11. The method of claim 5, said determining the fastest site comprises requesting a file corresponding to each URL link.

12. The method of claim 11, said determining the fastest site comprises recording an amount of time between a server site SYN plus ACK and an ACK from the remote computer for each of the plurality of server sites.

13. The method of claim 12, further comprising generating a second Web page at each of the plurality of server sites and transmitting the Web page to the remote computer.

14. The method of claim 12, further comprising caching on a per network basis an identity of the fastest site at each of the plurality of server sites.

15. A computer readable medium having instructions stored thereon that, when executed by a processor, cause the processor to:
receive a Uniform Resource Locator (URL) request from a remote computer;
generate a timing Web page, said timing Web page comprising information regarding a plurality of server sites;
transmit the timing Web page to the client computer; and
determine a fastest site among the plurality of server sites.

16. The computer readable medium of claim 15, wherein the information comprises a list of locations of the plurality of server sites.

17. The computer readable medium of claim 15, wherein the information comprises a URL link to each of the plurality of server sites.

18. The computer readable medium of claim 16, said timing Web page comprising a Java Applet.

19. The computer readable medium of claim 16, said determining the fastest site comprises initiating a Transport Control Protocol (TCP) connection to each of the plurality of Web sites.

20. The computer readable medium of claim 18, said instructions further causing said processor to receive an identity of the fastest site from the client computer.

21. The computer readable medium of claim 20, said instructions further causing said processor to redirect the client computer to the fastest site.

22. The computer readable medium of claim 15, said determining the fastest site comprises requesting a file corresponding to each URL link.

23. The computer readable medium of claim 15, said determining the fastest site comprises recording an amount of time between a server site SYN plus ACK and an ACK from the remote computer for each of the plurality of server sites.

24. A method of accessing data over a network comprising:
generating a Uniform Resource Locator (URL) request to a first server site among a plurality of server sites;
receiving a timing Web page from the first server site, said timing Web page comprising information regarding the plurality of server sites; and
determining a fastest site among the plurality of server sites based on the timing Web page.

25. The method of claim 24, wherein the information comprises a list of locations of the plurality of server sites.

26. The method of claim 24, wherein the information comprises a URL link to each of the plurality of server sites.

27. The method of claim 24, said determining the fastest site comprises initiating a Transport Control Protocol (TCP) connection to each of the plurality of Web sites.

28. The method of claim 27, further comprising dropping all of the TCP connections except the TCP connection to the fastest site.

29. The method of claim 27, further comprising sending an identity of the fastest site to the first server site.
